(19) United States
(12) Patent Application Publication
(10) Pub. No.: US 2010/0108014 A1
(43) Pub. Date: May 6, 2010

(54) SPRAY COATING, METHOD OF FORMING SAME, SPRAY MATERIAL WIRE, AND CYLINDER BLOCK

(76) Inventors: Kota Kodama, Aichi (JP); Norita Miyamoto, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/532,917

(22) PCT Filed: Mar. 6, 2008
(86) PCT No.: PCT/JP2008/054552

§ 371 Date: Sep. 24, 2009

(30) Foreign Application Priority Data
Mar. 26, 2007 (JP) 2007-079466

(51) Int. Cl. F02F 1/00; C23C 4/06; C23C 18/32; C09D 1/00

(52) U.S. Cl. 123/193.2; 427/449; 106/1.05

(57) ABSTRACT

An arc spray coating that is superior in both wear resistance and machinability, method of forming same, an arc spray wire used to form such a coating, and a cylinder block on whose bore inner surface is formed such an arc spray coating are provided. To this end, the arc spray coating contains Fe as a main component, 0.01% to 0.15% by weight of C, and at least 0.12% by weight of N, and the arc spray wire (wire) contains Fe as a main component, 0.01% to 0.2% by weight of C, and 0.25% to 1.7% by weight of Si, and may further contain at least 11% by weight of Cr as another embodiment.

### TECHNICAL FIELD

The present invention relates to a cylinder block of an engine, a spray coating formed on the bore inner surface of the cylinder block and a method of forming same, as well as a spray material wire for forming such a spray coating.

### BACKGROUND ART

On cylinder bore inner surfaces of cylinder blocks, spray coatings for improving the corrosion resistance, wear resistance, and the like of the bore inner surfaces are formed by thermal spraying techniques in which a combustion flame (flame) is generated by an arc, plasma, gas, or the like, various metals and alloys are instantly melted, and spray particles that have been atomized (microparticulated) by compressed air are made to impact/solidify and adhere.

Incidentally, as wires for spraying (wires) used in arc spraying, ferrous material wires having a high carbon content are used in order to improve the wear resistance of the spray coating. For example, with respect to the spray materials disclosed in Patent Document 1, there is disclosed a spray material comprising 0.3% to 2.0% by weight of C, 3% to 20% of Cr, and 2% to 7% by weight of Si.

Improved wear resistance may be expected as the carbon content becomes higher. On the other hand, machinability (reducibility of machining tip wear amount) becomes poorer (deteriorates), and a boring process using a hard tip, which is a finishing process for a spray coating, becomes difficult. This reduction in machinability leads to a reduction in the yield of the spray coating process as a whole, and it also leads to degradation in the quality of the spray coating (dimensional tolerance of the spray coating is large). In addition, as the carbon content increases, the drawability of the arc spray wire becomes poorer. This leads to increased wire costs, the wires become more rigid, feedability thereof in the thermal spray apparatus becomes poorer, and wire feeding also becomes difficult. On the other hand, it is clear that as the carbon content decreases, the required hardness would not be obtained, and the coating would have poor wear resistance.

Therefore, with respect to arc spray coatings formed on cylinder bore inner surfaces, the development of an arc spray coating superior in both its wear resistance and machinability, as well as the development of an arc spray wire for forming such a coating have been urgent problems in the field.

Patent Document 1

Japanese Patent Publication (Kokai) No. 2004-244709 A

### DISCLOSURE OF THE INVENTION

The present invention is made in view of the problems above, and its object is to provide an arc spray coating that is superior in both wear resistance and machinability, a method of forming same, an arc spray wire used in forming such a coating, and a cylinder block in which such an arc spray coating is formed on the bore inner surface thereof.

In order to achieve the object above, an arc spray coating according to the present invention is characterized in that it contains Fe as a main component, 0.01% to 0.15% by weight of C, and at least 0.12% by weight of N.

An arc spray coating of the present invention is suitable for being formed on the bore inner surface of a cylinder block of an engine. However, besides bore surfaces of cylinder blocks, it may also be formed on internal surfaces of appropriate tubular members for which it is necessary to improve the wear resistance and the like thereof, such as the sliding surface of a cylinder constituting a cylinder unit mechanism that is an actuator.

This arc spray coating is formed of iron alloy particles whose main component is Fe (pure iron), and which contains, where the coating as a whole is 100% by weight, 0.01% to 0.15% by weight of C (carbon), and at least 0.12% by weight of N (nitrogen).

Here, the carbon content range mentioned above is a range for simultaneously giving the arc spray coating the desired hardness (wear resistance) as well as the desired machinability. As compared to conventional arc spray coatings which are designed to improve wear resistance only, the carbon content range thereof is set to a lower range. Desired machinability as used herein may be defined in terms of, for example, the wear amount of the flank face when a boring process or the like is performed on the arc spray coating with a hard tip.

When the carbon content is less than 0.01% by weight, the coating is too soft, and a predetermined wear resistance cannot be achieved. In addition, once the carbon content exceeds 0.15% by weight, the wear amount of the flank face mentioned above becomes greater during the boring process. Further, it becomes impossible to use the later-described commercially available arc spray wires, thereby causing coating quality degradation and a sharp rise in processing cost.

The desired wear resistance mentioned above is achieved by having not only carbon of the above-mentioned content range contained, but also nitrogen of the above-mentioned content range. This nitrogen is the nitrogen that is present in the air, and is incorporated into the atomized spray particles. The present inventors have discovered the fact that the wear resistance of spray coatings improves by having nitrogen of the above-mentioned content range. Here, the desired wear resistance may be defined in terms of the depth of wear of the arc spray coating. For example, a comparable or lesser depth of wear to or than that of a cast iron liner cast into the cylinder bore may be set as a reference value.

An arc spray coating of the present invention is one in which the carbon content and the nitrogen content have been so adjusted to satisfy both the desired wear resistance and machinability. It at least has a wear resistance comparable to that of a cast iron liner, and also allows for an efficient implementation of a boring process. Therefore, the processing accuracy of the ultimately formed coating surface is also superior, and it is possible to obtain a sliding surface with high durability.

In addition, an arc spray wire according to the present invention is an arc spray wire for forming the above-mentioned arc spray coating, and is characterized in that it contains Fe as a main component, 0.01% to 0.2% by weight of C, and 0.25% to 1.7% by weight or Si.

According to experiments by the inventors, it has been substantiated that, as components of an arc spray wire (wire) for forming an arc spray coating comprising Fe as a main component, 0.01% to 0.15% by weight of C, and at least 0.12% by weight of N, first, 0.01 to 0.2% by weight of carbon is required as the carbon content of a wire for realizing the above-mentioned carbon content in the coating, and that 0.25% to 1.7% by weight of silicon is required as the silicon content of a wire for realizing the above-mentioned nitrogen content in the coating.

During spraying, an arc spray wire is fed, and this is melted and atomized. However, when the carbon content of the arc spray wire is less than 0.01% by weight, the wire buckles during wire feeding, and spraying processability is severely compromised. On the other hand, once the carbon content of the wire exceeds 0.2% by weight, the carbon content of the spray coating exceeds 0.15% by weight, thereby impairing the machinability of the spray coating.

In addition, when the silicon content is less than 0.25% by weight, the bond strength of the arc spray coating to the bore inner surface becomes extremely low, and once it exceeds 1.7% by weight, the nitrogen content in the arc spray coating becomes less than 0.12% by weight, thereby compromising the wear resistance of the coating. In other words, the present inventors have discovered that the silicon content in the arc spray wire plays an important role in incorporating a predetermined amount of nitrogen from air.

In addition, a preferred embodiment of an arc spray wire according to the present invention is characterized in that at least 11% by weight of Cr is further contained in addition to the contained components of the wire mentioned above.

According to experiments by the present inventors, it has been discovered that an effect may be achieved where the nitrogen content in the formed coating is increased when the above-mentioned wire contains 11% by weight or more of chromium. It is noted that this effect cannot be expected when the chromium content is less than 11% by weight. Therefore, a predetermined nitrogen content is secured by the silicon contained in the wire. It is noted that once the chromium content exceeds 20% by weight, a sufficient hardness can no longer be achieved for the spray coating due to an increase in ferrite. Therefore, it is preferable that the contained amount thereof be 11% by weight or greater but less than 20% by weight.

By forming atomized particles using an arc spray wire of the present invention mentioned above and applying them to a bore surface, it is possible to reliably form an arc spray coating having superior wear resistance and machinability, as well as superior bond strength with respect to the bore surface.

Further, a method of forming an arc spray coating according to the present invention is characterized in that it comprises: a first step of preparing an arc spray wire containing Fe as a main component, 0.01% to 0.2% by weight of C, and 0.25% to 1.7% by weight of Si; and a second step of melting the arc spray wire with a combustion flame, and forming on a cylinder bore inner surface an arc spray coating, which contains Fe as a main component, 0.01% to 0.15% by weight of C, and at least 0.12% by weight of N, while supply compressed air to the molten arc spray wire.

More specifically, the arc spray coating is formed by making the surface roughness of the spray coating be at or below a certain roughness level by performing a honing process after the first step and the second step mentioned above. It is noted that the surface roughness of the coating immediately after arc spraying may, in some cases, be extremely high such as an Rₘₐₓ of approximately 180. When a honing process (polishing process) that uses a diamond wheel or a CBN wheel is performed thereon, there is a risk where the central axis of the honing process tool may become displaced, and unevenness in thickness may occur in the coating after the process. Thus, in such cases, by performing a boring process (cutting process) by means of a CBN cutter bit prior to the honing process, the surface roughness of the coating may be kept below a certain level, and the problem of the occurrence of unevenness in thickness may be resolved by thereafter performing the honing process.

It is noted that, for the arc spray wire used, a wire containing 11% by weight or more of chromium as described above may naturally be used.

As can be understood from the description above, according to a spray coating, a method of forming same, and a spray material wire of the present invention, it is possible to form an arc spray coating that has superior wear resistance and machinability, and that even has superior bond strength with respect to a bore surface. Therefore, by producing a cylinder block on whose bore surface is formed such a spray coating, it is possible to improve the durability thereof, and it leads to reduced production costs as a result of increased production yield thereof.

### BRIEF DESCRIPTION OF THE DRAWINGS

FIG. 1 is a schematic view showing a thermal spray apparatus.

FIG. 2 is an enlarged view of a spray gun.

FIG. 3 is a view of FIG. 2 in the direction of arrow

FIG. 4 is graph showing experiment results for determining the carbon content in an arc spray coating, and is a graph relating to the flank face wear amount of coatings and carbon content.

FIG. 5 is a cross-sectional photograph and a profile photograph of an arc spray coating after a cutting process, whose carbon content is 0.05% by weight, and a cross-sectional photograph and a profile photograph of an arc spray coating after a cutting process, whose carbon content is 0.50% by weight.

FIG. 6 is a graph showing experiment results for determining the nitrogen content in an arc spray coating, and is a graph relating to the depth of wear of coatings and nitrogen content.

FIG. 7 is a graph showing experiment results for determining the carbon content in a wire, and is a graph relating to the carbon content in wires and the carbon content in coatings.

FIG. 8 is a graph showing experiment results for determining the silicon content in a wire, and is a graph relating to the silicon content in wires and the nitrogen content in coatings.

FIG. 9 is a graph showing experiment results for determining the silicon content in a wire, and is a graph relating to the silicon content in wires and the bond strength of coatings with respect to a bore surface.

FIG. 10 is a graph showing experiment results for determining the chromium content in a wire, and is a graph relating to the chromium content in wires and the nitrogen content in coatings.

In the figures, 1 denotes a base, 2 a support portion, 3 a spray tool, 4 a controller, 51 an ascent/descent drive motor, 52 a rotation drive motor, 6 a spray gun, 61 a tip Member, 62 an atomizing nozzle, 63 an auxiliary nozzle, 7 a palette, 10 a thermal spray apparatus, C a cylinder block, C1 a bore, A1 auxiliary air, and A2 atomizing air.

### BEST MODE FOR CARRYING OUT THE INVENTION

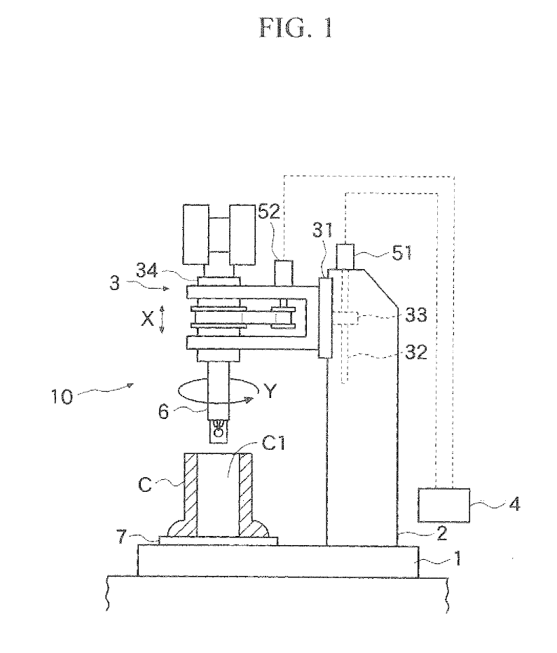

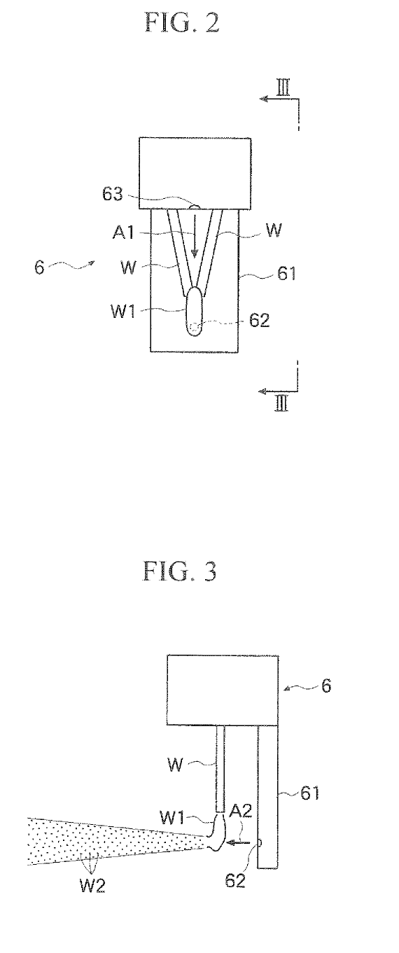

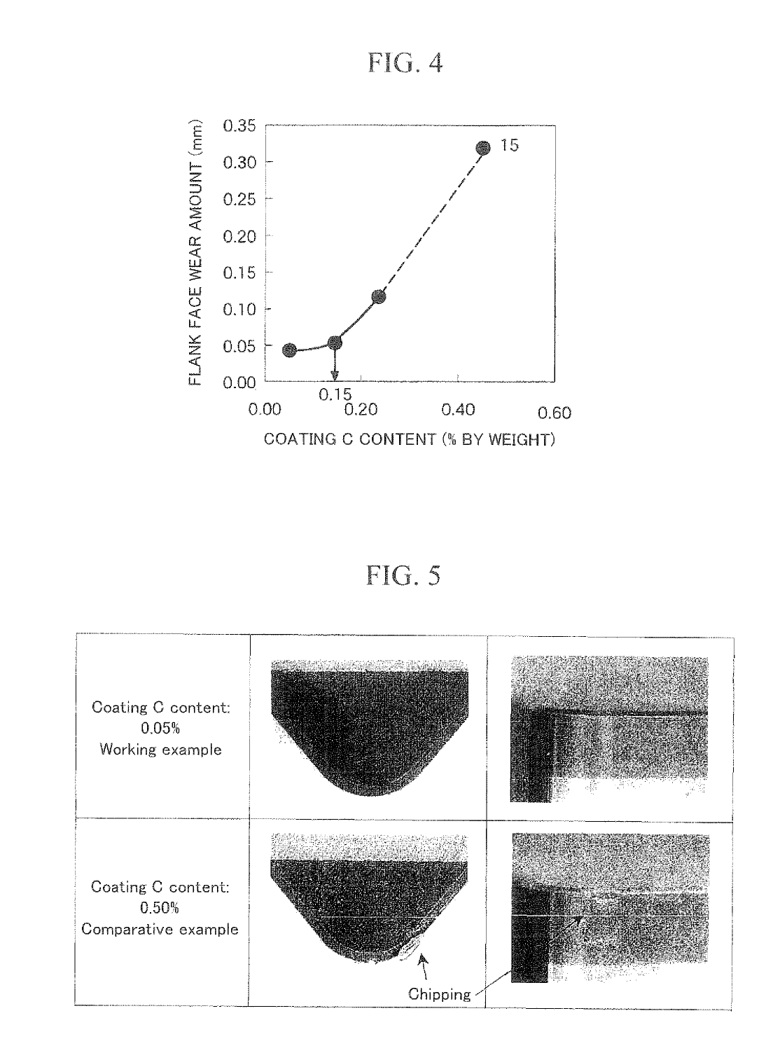

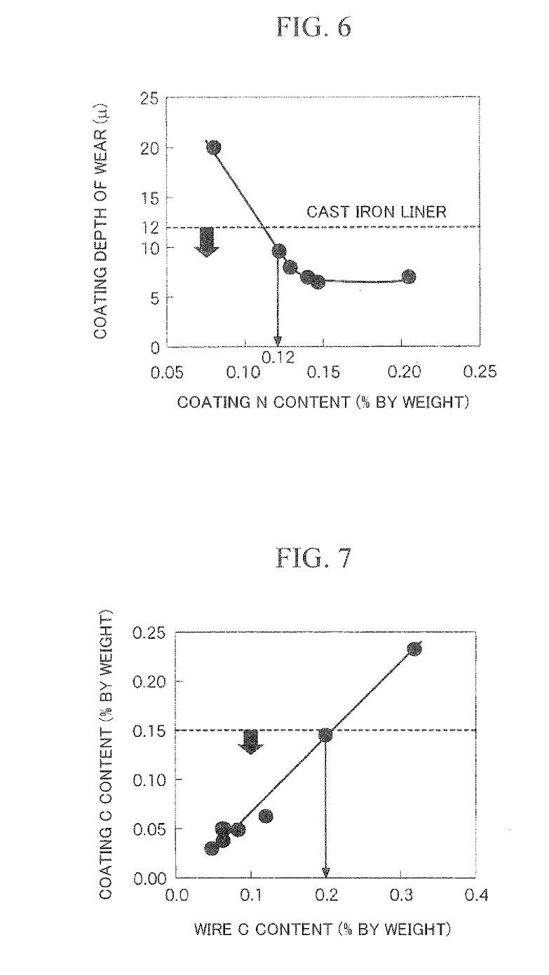

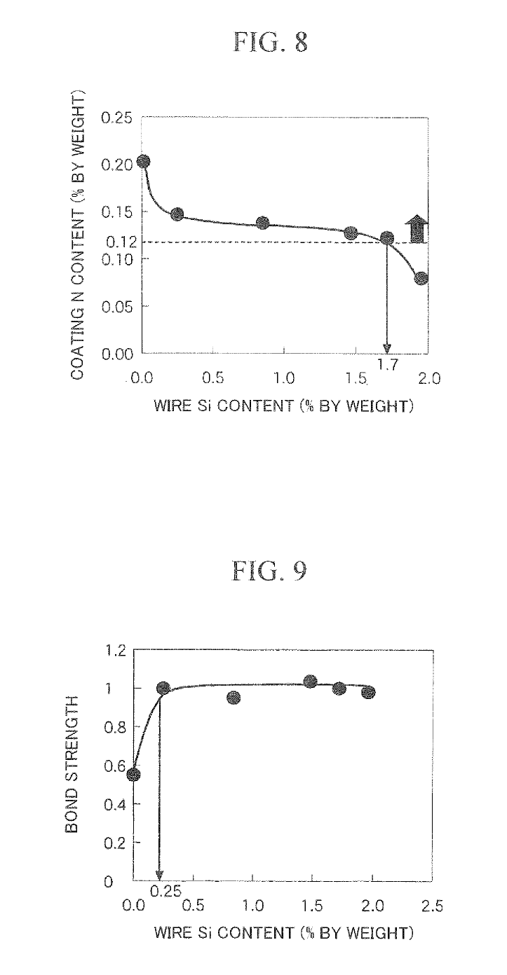

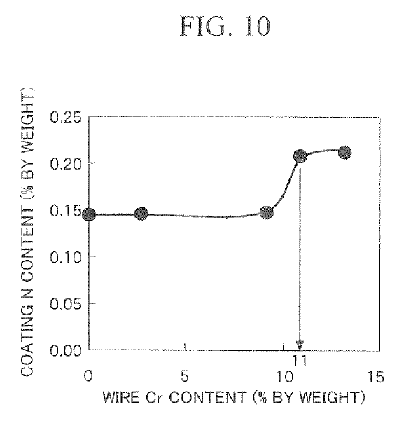

An embodiment of the present invention is described below with reference to the drawings. FIG. 1 is a schematic view showing a thermal spray apparatus. FIG. 2 is an enlarged view of a spray gun. FIG. 3 is a view of FIG. 2 in the direction of arrow III-III. FIG. 4 is a graph showing experiment results for determining the carbon content in an arc spray coating, and is a graph relating to the flank face wear amount of coatings and carbon content. FIG. 5 is a cross-sectional photograph and a profile photograph of an arc spray coating after a cutting process, whose carbon content is 0.05% by weight, as well as a cross-sectional photograph and a profile photograph of an arc spray coating after a cutting process, whose carbon content is 0.50% by weight. FIG. 6 is a graph showing experiment results for determining the nitrogen content in an arc spray coating, and is a graph relating to the depth of wear of coatings and nitrogen content. FIG. 7 is a graph showing experiment results for determining the carbon content in a wire, and is a graph relating to the carbon content in wires and the carbon content in coatings. FIG. 8 is a graph showing experiment results for determining the silicon content in a wire, and is a graph relating to the silicon content in wires and the nitrogen content in coatings. FIG. 9 is a graph showing experiment results for determining the silicon content in a wire, and is a graph relating to the silicon content in wires and the bond strength of coatings with respect to a bore surface. FIG. 10 is a graph showing experiment results for determining the chromium content in a wire, and is a graph relating to the chromium content in wires and the nitrogen content in coatings.

FIG. 1 is a schematic view of an embodiment of a thermal spray apparatus that is used in forming an arc spray coating of the present invention on a bore inner surface of a cylinder block. This thermal spray apparatus 10 substantially comprises: a base 1; a support portion 2 that is supported by and fixed to the base 1; a spray tool 3 that slides up and down along the support portion 2; a spray gun 6 that is installed at the tip of this spray tool 3; a controller 4; and a palette 7 that a cylinder block C is to be placed on and fixed to.

The support portion 2 is placed on the base 1; and supports a slider 31, which is provided on the spray tool 3, in a freely ascendible/descendible manner. The controller 4 is connected to an ascent/descent drive motor 51, which is installed on the upper portion of the support potion 2, and a rotation drive motor 52. A helical screw 32 is attached to a rotary shaft of the ascent/descent drive motor 51. The helical screw 32 is mated with a support 33 that is fixed to the slider 31. The controller 4 controls the rotation direction and rotation speed of the ascent/descent drive motor 51. The spray tool 3 is able to ascend and descend at a desired speed by means of the rotation of the ascent/descent drive motor 51.

A tool main body 34 of the spray tool 3 has the spray gun 6 installed on its tip. The tool main body 34 and the spray gun 6 rotate about their axes (direction Y in the figure) by means of the rotation drive motor 52. In addition, the palette 7 is installed on the base 1, and fixates the cylinder block C placed thereon. When the tool main body 34 and the spray gun 6 ascend/descend (direction X in the figure) within a bore C1 of the cylinder block C in a rotating posture, spray particles are sprayed onto the bore surface of the bore C1. It is noted that the cylinder block C is formed from an aluminum alloy casting, and JISAC2C, ADC12 and the like, for example, may be used.

FIG. 2 is an enlarged view of the spray gun 6, and FIG. 3 is a side view thereof. When the thermal spray apparatus 10 performs spraying, a voltage is applied to power lines not shown in the figures. An arc is generated at the tip contact portion of arc spray wires (wires W). Due to the heat therefrom, the tips of the wires W melt. An amount of the wires W that has been melted and consumed is drawn out and fed from a reel by means of rotation of a feed roller not shown in the figures. When air is supplied to a hose not shown in the figures, auxiliary air A1 blows out from an auxiliary nozzle 63, while atomizing air A2 blows from an atomizing nozzle 62 provided in a tip member 61 of the spray gun 6 (see FIG. 3).

FIG. 2 schematically shows a state where the tips of the wires W have melted, and the auxiliary air A1, which is compressed air, is blown out from the auxiliary nozzle 63. Here, the nitrogen components in the air are added into a droplet W1, and a predetermined nitrogen content is thus made to be contained in pure iron having a predetermined carbon content.

In addition, as shown in FIG. 3, the atomizing air A2 that is blown from the atomizing nozzle 62 is blown onto the droplet W1. As a result, the droplet W1 is dispersed into fine spray particles W2, . . . Under these conditions, when the spray tool 3 ascends or descends within the bore C1 of the cylinder block C at a predetermined speed while rotating the spray gun 6, the spray particles W2, . . . are sprayed onto the inner surface of the bore C1. The sprayed spray particles W2, . . . adhere to the inner surface of the bore C1 to form a spray coating.

Experiments, and the results thereof, for determining the contained components forming an arc spray coating material of the present invention and the contained amounts thereof, as \veil as the contained components forming a wire for forming such a spray coating and the contained amounts thereof, are described in detail below.

[Experiment for Determining the Carbon Content in an Arc Spray Coating, and Results Thereof]

An arc spray coating of the present invention comprises an alloyed iron powder of main component Fe—C—N. First, an experiment for determining the carbon content will be described. In forming a spray coating that is superior not only in wear resistance but also in machinability, its carbon content will be determined from the viewpoint of machinability in particular. As will be described later, this is because it is possible to effectively form a spray coating that is superior in both performance characteristics of wear resistance and machinability by determining the carbon content in such a manner as to satisfy a predetermined level of machinability performance, and determining a predetermined level of wear resistance performance by way of the nitrogen content based on this carbon content.

The testing method was such that fifty cast iron liners with an inner diameter of 82 mm were prepared instead of cylinder blocks, and fifty arc spray coatings of a thickness of 0.45 mm were consecutively formed on the inner surfaces of the respective cast iron liners. Thereafter, the flank face wear amounts from boring processes performed on the formed spray coatings were measured to assess machinability. It is noted that the specific processing conditions of the boring process were that a dry cutting process was performed with a grinding apparatus having a cutting tip comprising 80% by weight of CBN as the grinding apparatus at rotation speed: V=600 m/min, feed=0.3 mm/rotation, and depth of cut: 0.3 mm. Results thereof are shown in Table 1 and FIG. 4.

TABLE 1

| Carbon Content (% by weight) | | Quantity | Flank Face Wear |
|---|---|---|---|
| Wire | Spray Coating | Processed | Amount (mm) |
| 0.06 | 0.05 | 50 | 0.045 |
| 0.20 | 0.15 | 50 | 0.055 |
| 0.32 | 0.23 | 50 | 0.12 |
| 0.61 | 0.45 | 15 | 0.32 |
| 0.79 | 0.50 | 15 | chipping |

Table 1 shows the carbon content in the corresponding wire in addition to the carbon content in the spray coating. Here, the wire whose carbon content is 0.20% by weight is one that is widely sold in general, examples of which include JIS SWRM 20K, 22K and the like. By using this commercially available wire, it is possible to make the production cost of the coatings cheaper. Therefore, the present inventors adopted as the carbon content of the spray coating the carbon content of 0.15% by weight (<content: 0.20% by weight calculated from the reference value) in the spray coating formed when this wire with a Carbon content of 0.20% by weight was used.

It is noted that when the carbon content of the spray coating was made to be 0.50% by weight, chipping occurred in all fifteen test cast iron liners. This is because the coating itself became brittle due to excessive carbon contents.

FIG. 5 shows cross-sectional photographs (left) and profile photographs (right) of coatings after testing with respect to a spray coating with a carbon content of 0.05% by weight (working example) and a spray coating with a carbon content of 0.50% by weight (comparative example). As is apparent from the photographs, whereas chipping is present in the coating in the comparative example, a smooth coating surface is formed in the working example:

[Experiment for Determining the Nitrogen Content in an Arc Spray Coating, and Results Thereof]

Next, a block was attached to a jig with an inner diameter of 82 mm compliant with ASTM D2714, and arc spraying using various wires having the compositions shown in Table 2 below was performed. After arc spraying, a polishing process was performed and a sliding test was performed. Here, the wire feed rate during spraying was 100 mm/sec, wire diameter was φ1.6 mm, and the applied voltage was 30 V. In addition, the carbon content of each wire was adjusted to 0.15% by weight or below. The nitrogen content in the coating formed when each wire was used is indicated in Table 2. The depth of wear was measured for the coating of each nitrogen content, and the result thereof is shown in Table 2 and FIG. 6.

TABLE 2

| | Wire Composition | | | | Coating Composition | | | |
|---|---|---|---|---|---|---|---|---|
| | (% by weight) | | | | (% by weight) | | Depth of | Bond Strength |
| | C | Si | Mn | Cr | C | N | Wear (μm) | (normalized value) |
| Material A | 0.05 | 1.95 | 0.43 | | 0.03 | 0.08 | 20 | 0.98 |
| Material B | 0.06 | 1.71 | 1.86 | | 0.04 | 0.12 | 9.6 | 1 |
| Material C | 0.06 | 1.47 | 0.38 | | 0.05 | 0.13 | 8 | 1.03 |
| Material D | 0.06 | 0.84 | 1.39 | | 0.05 | 0.14 | 7 | 0.95 |
| Material E | 0.08 | 0.25 | 1.10 | 0.01 | 0.05 | 0.15 | 6.5 | 1 |
| Material F | 0.12 | 0.02 | 1.91 | | 0.06 | 0.20 | 7 | 0.55 |

With respect to bond strength, it is noted that the bond strength of material B is taken to be 1, and the strengths of others are normalized. In FIG. 6, 12 μm, which is the depth of wear of the cast iron liner, is indicated as a reference value in the present experiment. From the experiment, it was substantiated that the nitrogen content range in the coating for which the depth of wear was less than the referential 12 μm was 0.12% by weight or above for arc spray coatings whose carbon content in the coating was adjusted to 0.15% by weight or below.

[Determination of the Carbon Content and Silicon Content in a Wire, Experiment for Determining the Silicon Content, and Results Thereof]

First, the carbon content in a wire for forming a coating, whose carbon content would be 0.15% by weight or less, can be determined by forming arc spray coatings using various wires of which the carbon content is varied. Such experiment results are shown in FIG. 7.

From FIG. 7, it has been substantiated that the formation of a coating whose carbon content is 0.15% by weight or less can be realized by setting the carbon content in the wire to 0.2% by weight or less.

On the other hand, through experiments by the present inventors using wires with varying silicon contents, it has been substantiated that a predetermined amount of silicon contained in the wire plays an important role when the spray coating incorporates a predetermined amount of nitrogen from the air. This can be explained based on Table 2 above and FIG. 8. To explain Table 2 again, the compositions of the respective wires used are such that the silicon content is varied within a range of 0.43% to 1.91% by weight under conditions where the carbon content is kept substantially constant.

From the experiment, it was substantiated that the nitrogen content in the formed coating can be made to be 0.12% by weight or above as targeted by adjusting the silicon content to 1.7% by weight or below. Therefore, the upper limit value for the silicon content in the wire may be defined at 1.7% by weight.

On the other hand, the lower limit value of the silicon content in the wire may be defined from the bond strength of the formed coating with respect to the bore inner surface. The present inventors performed bond strength tests therefor. Briefly, in the experiment, an ADC 12 cylinder block having a cylinder bore with an inner diameter of 82 min was formed, and arc spraying was performed using each wire with a wire diameter of φ1.6 mm whose composition is indicated in Table 2 above, at a feed rate of 100 mm/sec and an applied voltage of 30 V.

The bond strength was assessed by cutting out a coating specimen from the bore, and measuring the strength when this coating was sheared. The test results are shown in Table 2 and FIG. 9. It is noted that, in the test results, the bond strength of the specimen from when material B, where the silicon content of the wire is approximately 1.7% by weight, was used was taken to be 1, and the results for the specimens by other wires were normalized.

In the experiment, the bond strength of the coating dropped sharply when the silicon content in the wire was less than 0.25% by weight, and the values thereof were substantially the same at or above 0.25% by weight. From these experiment results, by defining the lower limit value of the silicon content in the wire at 0.25% by weight, it becomes possible to maintain the bond strength of the coating with respect to the bore surface at or above a certain level.

[Experiment for Determining the Chromium Content in a Wire, and Results Thereof]

The present inventors focused on the chromium content in a wire as a factor that increases the nitrogen content in the spray coating, and examined the nitrogen content of coatings formed using wires having compositions in which the carbon content is 0.2% by weight or below, the nitrogen content is 0.25% to 1.7% by weight, and the chromium content is in the range of 0% to 13.2% by weight. It is noted that the experiment conditions here are the same as those for the experiment above for determining the silicon content. The wire compositions used in this experiment and the experiment results are shown in Table 3 below and in FIG. 10. It is noted that, as methods for analyzing coating compositions in Table 2 and Table 3, carbon is by JIS G 1211 iron and steel—methods for determination of carbon content (infrared absorption method after combustion in a high-frequency induction furnace), silicon is by JIS G 1212 iron and steel—methods for determination of silicon content, manganese and chromium are by JIS G 1258 iron and steel—inductively coupled plasma atomic emission spectrometric method, and nitrogen is by JISG1228 iron and steel—methods for determination of nitrogen content.

TABLE 3

| | Wire Composition | | | | Coating Composition | |
|---|---|---|---|---|---|---|
| | (% by weight) | | | | (% by weight) | |
| | C | Si | Mn | Cr | C | N |
| Material E | 0.08 | 0.25 | 1.10 | 0 | 0.05 | 0.15 |
| Material G | 0.08 | 0.40 | 0.85 | 2.7 | 0.06 | 0.15 |
| Material H | 0.08 | 0.36 | 1.53 | 9.2 | 0.06 | 0.15 |
| Material I | 0.11 | 0.41 | 0.35 | 10.9 | 0.06 | 0.21 |
| Material J | 0.12 | 0.45 | 0.52 | 13.2 | 0.06 | 0.21 |

From the experiment, it was substantiated that the nitrogen content in the coating increases by approximately 40% in the 9% to 11% by weight range of chromium content. From these results, it was concluded that at least 11% by weight of chromium should be contained in the wire in order to increase the nitrogen content in the coating.

Embodiments of the present invention have been described in detail above with reference to the drawings. However, specific configurations are not to be limited to these embodiments, and even if design changes and the like are made within a scope that does not depart from the spirit of the present invention, they are to be included in the present invention.

1. An arc spray coating comprising Fe as a main component, 0.01% to 0.15% by weight of C, and at least 0.12% by weight of N, wherein the N had been present in the air and incorporated into atomized spray particles.

2. A cylinder block characterized in that the arc spray coating according to claim 1 is formed on a bore inner surface thereof.

3. An arc spray wire for forming the arc spray coating according to claim 1, the arc spray wire comprising Fe as a main component, 0.01% to 0.2% by weight of C, and 0.25% to 1.7% by weight of Si.

4. An arc spray wire for forming the arc spray coating according to claim 1, the arc spray wire comprising Fe as a main component, 0.01% to 0.2% by weight of C, 0.25% to 1.7% by weight of Si, and at least 11% by weight of Cr.

5. An arc spray coating forming method, comprising:
a first step of preparing an arc spray wire comprising Fe as a main component, 0.01% to 0.2% by weight of C, and 0.25% to 1.7% by weight of Si; and
a second step of melting the arc spray wire with a combustion flame, and forming the arc spray coating according to claim 1 on a cylinder bore inner surface while supplying compressed air to the molten arc spray wire.
